(19) United States
(12) Patent Application Publication
(10) Pub. No.: US 2020/0327467 A1
(43) Pub. Date: Oct. 15, 2020

(54) METHOD AND SYSTEM FOR AUTOMATED PROJECT MANAGEMENT WORKFLOW AND MONITORING

(71) Applicant: Tim Davies, Peterborough (GB)

(72) Inventor: Tim Davies, Peterborough (GB)

(21) Appl. No.: 16/381,001

(22) Filed: Apr. 11, 2019

(51) Int. Cl. G06Q 10/06; G10L 13/08; G10L 25/63

(52) U.S. Cl. CPC G06Q 10/06312; G06Q 10/063118; G06Q 10/06313; G06Q 10/063116; G10L 13/08; G10L 25/63; G06Q 10/063114

(57) ABSTRACT

A method for monitoring and assessing a project, the method comprising; receiving, by at least first processors, a request for a project, assessing, by the requested project, wherein a project type is determined, and the project type has a plurality of tasks associated with the project type, establishing, by a team of resources, wherein the team of resources are based on the project type and the plurality of tasks associated with the project type, generating, by a plan for the project, wherein the plan is based on the team of resources, the project type and comprises a plurality of chronologically structured tasks, identifying, by the completion of at least one task, wherein an asset is generated by at least one of the team of resources, confirming, by the completion of the plurality of tasks associated with the requested project, and storing, by the requested project data.

### BACKGROUND

This disclosure relates generally project management, and particularly to a method, computer program and computer system for automated project management and monitoring issues or obstacles which arise through the project life time.

Project Management is inherently variable in terms of project type, client, resources, duration and complexity. However, one the most significant factors for success is the Project Manager. Individual Project Managers tend to focus and specialize on a specific project type, allowing experience to complement their delivery toolkit, increasing likelihood of success, however this learned capability is not transferable.

The cost of poor project performance is 9.9% of total project investment. Scaled to encompass total global capital investment this equates to $1M every 20 seconds or $2T every year. Even in organizations with High Maturity Project Management Functions, the average percentage of projects completed; on time is 64%, on budget 67%, meet business intent 78% with 12% of project deemed failures.

Projects involving remote distributed teams are a further complication and the growing adoption of Gig based delivery will lead to a greater proportion of this type of project, which the current toolsets do not account for.

Therefore, it is desired for a method, computer program, or computer system to create a central system to plan the project, connect the resources, establish a timeline and project deliverables, all while maintaining communication between parties and monitor task completions, and project adjustments.

### SUMMARY

In a first embodiment, the present invention is a method for monitoring and assessing a project, the method comprising; receiving, by at least first processors, a request for a project, assessing, by at least one processor, the requested project, wherein a project type is determined, and the project type has a plurality of tasks associated with the project type, establishing, by at least one processor, a team of resources, wherein the team of resources are based on the project type and the plurality of tasks associated with the project type, generating, by at least one processor, a plan for the project, wherein the plan is based on the team of resources, the project type and comprises a plurality of chronologically structured tasks, identifying, by at least one processor, the completion of at least one task, wherein an asset is generated by at least one of the team of resources, confirming, by at least one processor, the completion of the plurality of tasks associated with the requested project, and storing, by at least one processor, the requested project data.

In a second embodiment, the present invention is a computer program product for monitoring and assessing a project, the method comprising; one or more computer readable storage media and program instructions stored on the one or more computer readable storage media, the program instructions comprising; program instructions to receive a request for a project, program instructions to assess the requested project, wherein a project type is determined, and the project type has a plurality of tasks associated with the project type, program instructions to establish a team of resources, wherein the team of resources are based on the project type and the plurality of tasks associated with the project type, program instructions to generate a plan for the project, wherein the plan is based on the team of resources, the project type and comprises a plurality of chronologically structured tasks, program instructions to identify the completion of at least one of the plurality of tasks, wherein an asset is generated by at least one of the team of resources, program instructions to store the project data, wherein the team of resources, tasks, client, and the plurality of information associated with the requested project.

In a third embodiment, the present invention is a computer system for monitoring and assessing a project, the computer system comprising; one or more computer processors, one or more computer readable storage media, and program instructions stored on the one or more computer readable storage media for execution by, at least one of the one or more processors, the program instructions comprising; program instruction to receive a request for a project, program instruction to assess the requested project, wherein a project type is determined, and the project type has a plurality of tasks associated with the project type, program instruction to establish a team of resources, wherein the team of resources are based on the project type and the plurality of tasks associated with the project type, program instruction to generate a plan for the project, wherein the plan is based on the team of resources, the project type and comprises a plurality of chronologically structured tasks, program instruction to identify the completion of at least one task, wherein an asset is generated by at least one of the team of resources, program instruction to confirm the completion of the plurality of tasks associated with the requested project, and program instruction to store the requested project data.

### BRIEF DESCRIPTION OF THE DRAWINGS

FIG. 1 depicts a block diagram depicting a computing environment, in accordance with one embodiment of the present invention.

FIG. 2 depicts a flowchart of the operational steps of the project management process, in accordance with an embodiment of the present invention.

FIG. 3 depicts a flowchart of the operational steps of the project launch process, in accordance with an embodiment of the present invention.

FIG. 4 depicts a flowchart of the operational steps in the project management task delivery process, in accordance with an embodiment of the present invention.

FIG. 5 depicts a flowchart of the operational steps in the project management communication process, in accordance with an embodiment of the present invention.

FIG. 6 depicts a flowchart of the operational steps in the project management escalation process, in accordance with an embodiment of the present invention.

FIG. 7 depicts a flowchart of the operational steps in the project management optimization process, in accordance with an embodiment of the present invention.

FIG. 8 depicts a flowchart of the operational steps in the project management hiring process, in accordance with an embodiment of the present invention.

FIG. 9 depicts a block diagram depicting the internal and external components of the server of FIG. 1, in accordance with one embodiment of the present invention.

FIG. 10 depicts a block diagram depicting a cloud computing environment, in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

Embodiments of the present invention discloses an approach to assist clients with their conditions in a safe and secure manner while also providing their providers with ample information to further assist the client gain control of their condition.

The present invention provides a method, system, or program for automating the delivery of a project without a human project manager, comprising, project definition, resource allocation, success forecasting, plan development, automated communication and delivery execution. In one embodiment, the method, system, or program uses a combination of cloud computing environments and machine learning resources (e.g. Web Portal, cloud storage and back end application logic, Machine Learning and pre-programmed algorithms, trained conversation service and communication through an email client, Instant Messaging and Notifications) to facilitate the project management process. Which is able to leverage a project management workflow, historic/trained project knowledge, historic resource performance, sentiment analysis and simulated Project Manager communications to monitor the project, determine when tasks are completed, identify issues which arise, providing potential solutions to these issues, and provide additional resources to the project that would assist in the efficiency of the project.

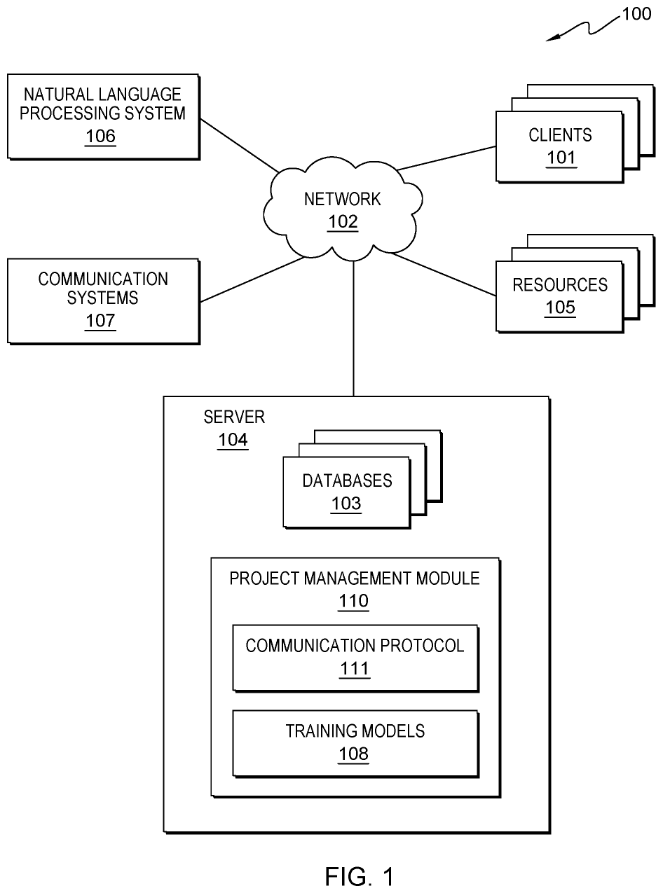

FIG. 1 depicts a block diagram of a computing environment 100 in accordance with one embodiment of the present invention. FIG. 1 provides an illustration of one embodiment and does not imply any limitations regarding the environment in which different embodiments maybe implemented.

In the depicted embodiment, computing environment 100 includes network 102, clients 101, server 104, resources 105, natural language processing system 106, and communication protocols 107. Computing environment 100 may include additional servers, computers, or other devices not shown.

Network 102 may be a local area network (LAN), a wide area network (WAN) such as the Internet, any combination thereof, or any combination of connections and protocols that can support communications between clients 101, server 104, resources 105, natural language processing system 106, and communication protocols 107. Network 102 may include wired, wireless, or fiber optic connections.

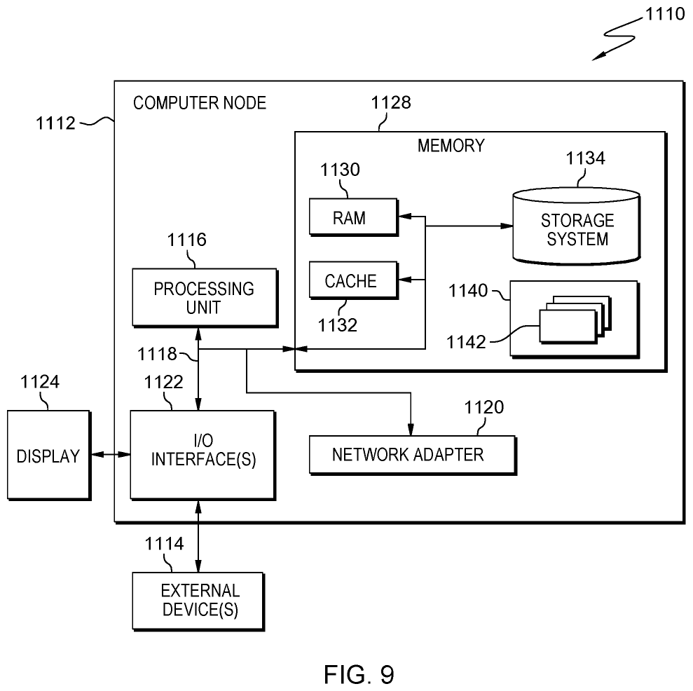

Client 101 represents the client with whom the project is being completed for. They may be a person, company, group, or other form of entity. The client 101 may operate through a management server, a web server, or any other electronic device or computing system capable of processing program instructions and receiving and sending data. In some embodiments, client 101 may use a laptop computer, tablet computer, netbook computer, personal computer (PC), a desktop computer, or any programmable electronic device capable of communicating with, server 104, resources 105, natural language processing system 106, and communication protocols 107 via network 102. In other embodiments, client 101 may represent a server computing system utilizing multiple computers as a server system, such as in a cloud computing environment. In another embodiment, client 101 represents a computing system utilizing clustered computers and components to act as a single pool of seamless resources. client 101 may include components, as depicted and described in further detail with respect to FIG. 9.

Server 104 may be a management server, a web server, or any other electronic device or computing system capable of processing program instructions and receiving and sending data. In another embodiments server 104 may be a laptop computer, tablet computer, netbook computer, personal computer (PC), a desktop computer, or any programmable electronic device capable of communicating via network 102. In one embodiment, server 104 may be a server computing system utilizing multiple computers as a server system, such as in a cloud computing environment. In one embodiment, server 104 represents a computing system utilizing clustered computers and components to act as a single pool of seamless resources. In the depicted embodiment databases 103, project management module 110, communication protocol 111, and training models 108 are located on server 104. Server 104 may include components, as depicted and described in further detail with respect to FIG. 9.

The project management module 110 is able to simulate the method and process of a high performing project manager across a variety of project types. Through the combination of a series of intelligent/smart modules. The modules interact without human intervention to achieve the methodical steps of a real-life project manager using a structured project delivery method traditionally utilized to facilitate an effective successful project. In some embodiments, the project management module 110 is delivered utilizing cloud-based computing it can be scaled infinitely based on demand. The project management module 110 is a combination of sub functions controlled and managed by the project management module 110. The workflow follows a series of steps to optimally prepare the project for launch, validate the project is ready to start, manage delivery of the team to budget and plan and optimize for future success based on the project learnings. In the depicted embodiment, project management module 110 utilizes network 102 to access the client 101, resources 105, natural language processing system 106, and communication protocols 107. In one embodiment, project management module 110 resides on may be located on another server or computing device, provided project management module 110 has access to the other components of the network 102.

Communication protocol 111 uses a combination of a highly trained conversation bot and scripted template language to mimic an experienced, knowledgeable and approachable project manager. All outgoing communications leverage the communications framework, ensuring that the appropriate style, content and impetus are applied when communicating with resources or clients. Through use of the natural language processing system 106, the communication protocol 111 is able to direct interaction between the client 101, the resources 105, and third parties. The communication protocol 111 provides the capability to naturally interact with the service users. In the depicted embodiment, communication protocol 111 utilizes network 102 to access the client 101, resources 105, natural language processing system 106, and communication protocols 107. In one embodiment, communication protocol 111 resides on may be located on another server or computing device, provided communication protocol 111 has access to the other components of the network 102.

Databases 103 may be a repository that may be written to and/or read by module 110 and protocol 111. Examples of data stored on databases is project types, project cases, resource(s) 105 data, client 101 data, project history, and other data associated with the projects. In the depicted embodiment databases 103 is a plurality of databases. In additional embodiments, databases 103 maybe a single database. In one embodiment, databases 103 is a database management system (DBMS) used to allow the definition, creation, querying, update, and administration of a database(s). In the depicted embodiment, databases 103 resides on server 104. In other embodiments, databases 103 resides on another server, or another computing device, provided that databases 103 is accessible to module 110.

Training module 108 trains the new project types. Through the use of the previously trained project types, the data collected from the previously trained project types, the record resources, task costs, and the like. The training module 108 is able to generate project types for future projects. The project types may be randomly determined, determined from variations in historic project types, or requested by a third party based on a potential future project. In the depicted embodiment, training module 108 utilizes network 102 to access the client 101, resources 105, natural language processing system 106, and communication protocols 107. In one embodiment, training module 108 resides on may be located on another server or computing device, provided training module 108 has access to the other components of the network 102.

Resource(s) 105 represents the person, entity, system, protocol, or program which is assisting the client 101 with the project (e.g. task, objective, or the like). The resource 105 may be accessed through a third party (e.g. freelancer) service or may be a third-party service. In embodiments, where the resource is a person or entity, they may operate through a management server, a web server, or any other electronic device or computing system capable of processing program instructions and receiving and sending data. In some embodiments, the resource(s) 105 may use a laptop computer, tablet computer, netbook computer, personal computer (PC), a desktop computer, or any programmable electronic device capable of communicating with clients 101, server 104, resources 105, natural language processing system 106, and communication protocols 107 via network 102. In other embodiments, Resource(s) 105 may represent a server computing system utilizing multiple computers as a server system, such as in a cloud computing environment. In another embodiment, Resource(s) 105 represents a computing system utilizing clustered computers and components to act as a single pool of seamless resources. Resource(s) 105 may include components, as depicted and described in further detail with respect to FIG. 9.

Natural language processing system 106 is a complete speech-based information query, retrieval, processing and presentation system(s). This system 106 is able to communicate with the module 110 through network 102. In some embodiments, the system 106 may be comprised of multiple sub-systems specializing in specific areas or functions of the natural language processes. For example, node analysis, text to speech engine, speech recognition engines, parser, dictionary and parses databases, and the like. In the depicted embodiment, the system 106 is accessible to the module 110 through network 102. In additional embodiments, the system 106 is accessible to the module 110 through additional networks or is located on the same server as the module 110.

Communication systems 107 provide the different methods in which the resources 105 are able to get in communication with the client 101. Through various messaging, audio, and other forms of communication systems the parties are able to communicate. Module 110 is also able to communicate with the parties through the systems 107. In the depicted embodiment, the system 107 is accessible to the module 110 through network 102. In additional embodiments, the system 107 is accessible to the module 110 through additional networks or is located on the same server as the module 110.

The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

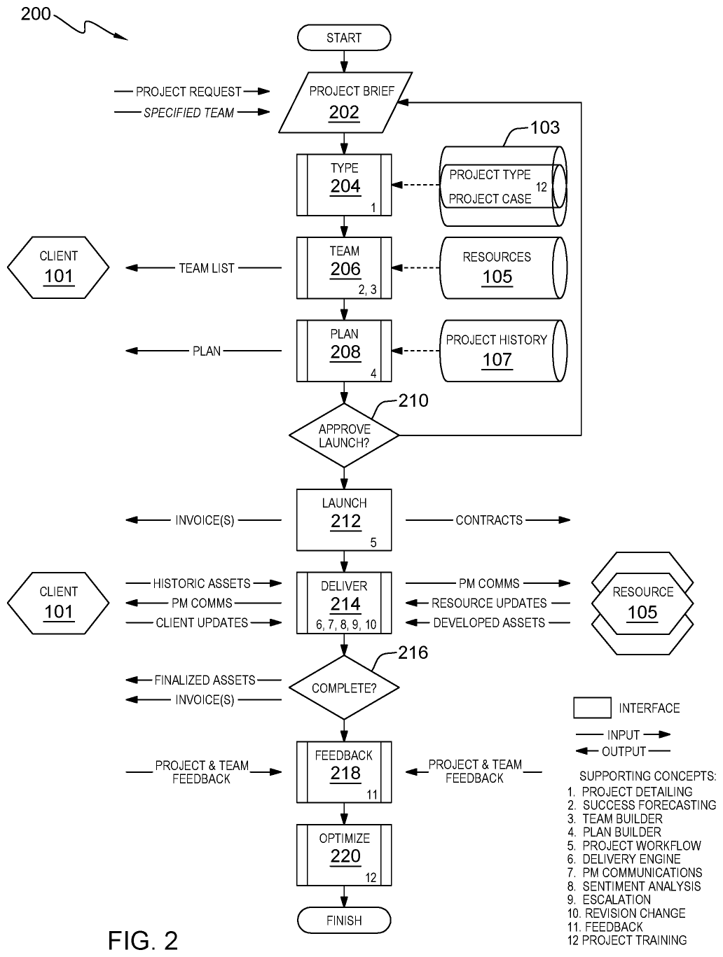

FIG. 2 depicts a flowchart of the operational steps in the project management process 200, in accordance with an embodiment of the present invention. The method(s) and associated process(es) are now discussed, over the course of the following paragraphs, with extensive reference to FIG. 2, in accordance with one embodiment of the present invention. Project process 200 is a combination of the sub processes/functions controlled and managed by the project management module 110. The workflow follows a series of steps to optimally prepare the project for launch, validate the project is ready to start, manage delivery of the team to budget and plan and optimize for future success based on the project learnings.

The project management module 110 receives 202 the project brief. The project brief contains various requests and information from a client 101 or third-party identifying information about the project the third party is able to provide. This may include project goals, specific teams, specific tasks, or the like. The project management module 110 is able to receive and process the information through various natural language processors and the like.

While, the overarching design enables any project to be delivered (that has been learned and configured), specific details of a given project type are customizable. When the plan is being generated 208, the client 101, a third party, or a resource(s) 105 may customize the plan (task, aspect, or the like). For example, in a video creation project, the ability to select between a 2D/3D video and 1 min/2 mins length and whether a Voice Over is required. Thus, enabling a higher-level project type to be defined in more detail and establish the specific underlying data required to enable the team builder 206 and plan builder 208 to function specifically to the requested project. The module 110 may use this to generate a new project template or the like.

Based on the information received, the project management module 110 assess 204 a project type. In some embodiments, the project management module 110 accesses a project type/case database 103 to determine if a preexisting project has been created or if a template project type can be implemented into the current project. If the module 110 is able to locate a project template or previously created project which is within a predetermined tolerance to the request for the current project. The module 110 identifies an acceptable project type template or a previously completed project within the similarity tolerance, the module 110 is able to identify and formulate 206 a team of resource(s) 105 which would be required to complete the various tasks associated with the project. In some embodiments the team may be comprised partially or wholly is humans or programs which are able to complete the tasks required by the project type. Module 110 accesses various resource databases, locations, services, or resource(s) 105 to compile a team of individuals or entities which can accomplish the tasks of the requested project. Module 110 is able to identify resource(s) 105, determine their availability for the task, their rating of the task, their ability (and history) to work with other resource(s) 105, and the like to create a full team for the requested project. The module 110 in some embodiments, submits the team to the client 101 for approval, review, modifications, questions, or adjustments.

In some embodiments the module 110 uses an understanding of the project type, client history and available resource(s) 105 to recommend a team with the highest likelihood of success. Potential combinations of resources are compared using output from the success forecasting service. The client 101 can influence the end selection by identifying preferred team members (i.e. those they would like to work on the project.) The other required resource(s) 105 can then be matched based on shared working history and previous outcomes to maximize the performance of the new project team.

Once the team setup has been completed and/or approved by the client 101, module 110 generates 208 a plan for the completion of the requested project. The plan establishes the project time line, the order of tasks, the milestones of the project, invoicing schedule, establishing the communication between the client 101 and resource(s) 105 as well as the resource(s) 105 and other resource(s) 105 in tasks which are related, and the other factors which the requested project is to be completed on/by. In some embodiments, the module 110 accesses a project history database 107 which provides previously completed projects of similarity to establish a plan that is realistic based on previously record data. To determine the time specific task may take, tentative fees or prices for the tasks (or project as a whole), and other variables about the project which are requested by the client 101, required by the module 110, or important to establish prior to beginning the project.

In some embodiments, the module 110 uses an understanding of project structure and usual tasks to develop a project plan 208 for the specific project. Projects are assessed based on their type and the required deliverables, historic matches (or near matches) are compared to identify core and secondary tasks. Historic Durations for specific tasks within the project type are compared and assessed using a mean and Std deviation. These slightly negatively biased durations are combined with the predicted task associations to establish the project timeline. A plan is then recommended to the client using the recommended Milestone structure and ordered core tasks with an expected timeline for delivery (based on the Hiring Managers stated Start Date).

Module 110 handles the deliver 214 of the project between the resource(s) 105 and the client 101. The module 110 communicates with the resource(s) 105 based on their assigned tasks, provides the completed work to client 101 for review, and communicates any issues, modifications, questions, or the like between the client 101 and the resource(s) 105. Once the final task of the project is completed (or approved by the client) 216, the module 110 submits the assets or completed project to the client 101 with any additional invoices or requirements of the client 101. In some embodiments, the module 110 follows a pre-defined workflow ensuring that each element (Milestone, Task, Asset) are assigned, tracked and delivered according to the approved plan.

In additional embodiments, when a task is not completed 216 on time, the module 110 enables dynamic revision to a given project plan based on changes to a task due date that has dependencies cause downstream impact (Plan management) or initiated based on clients 101 demand. The module 110 analyzes the impacts and is able to assess to see any changes to end delivery date and recommend new target dates to following resource(s) 105 task delivery. Based on the resource(s) 105 responses to recommended changes, the plan can either be delivered to plan or delivered to the new date (requiring client change management.)

The module 110 may, in some embodiments, request or receive feedback 218 from the resource(s) 105 and/or the client 101 based on the project. This may include how the resource(s) 105 worked together, how the resource(s) 105 worked with the client 101, how the client 101 felt about the resource(s) 105, the length of the project, and issues with the project, any comments (positive and/or negative) about the project, ways to improve upon the project, effectiveness of communication between the parties, and the like. The module 110, takes this information and processes the information to optimize 220 the overall process. This may include, but not limited to, adjusting project types/templates, identifying resource(s) 105 which work well together, adjusting timelines to a more realistic length, adjusting prices and fees, and the like.

Once the plan has been established, the module submits 110 the plan to the client 101 for their approval. If the client 101 approves, the module 110 launches 212 the project. If the client 101 does not approve, the process resets to the project assessment 102. When the project is launched 212, the module 110 completes the necessary requirements to begin the project. This may include submitting invoices to the client 101, formulating the contractual requirements with the resource(s) 105, and establishing the plan with all parties involved. In some embodiments, the module 110 generates the invoices and contracts. In additional embodiments, the module accesses a template invoice and contract. In some embodiments, the module 110 is able to make adjustments to template invoices or contracts based on the specifics of the resource(s) 105 and the task to be completed.

In some embodiments, a manual intervention is required based on a project request which does not fall within the template or similarity range of previous tasks. In these embodiments, module 110 identifies areas of similarities between the requested project and the previously completed or template projects and may not require a completely new project being created.

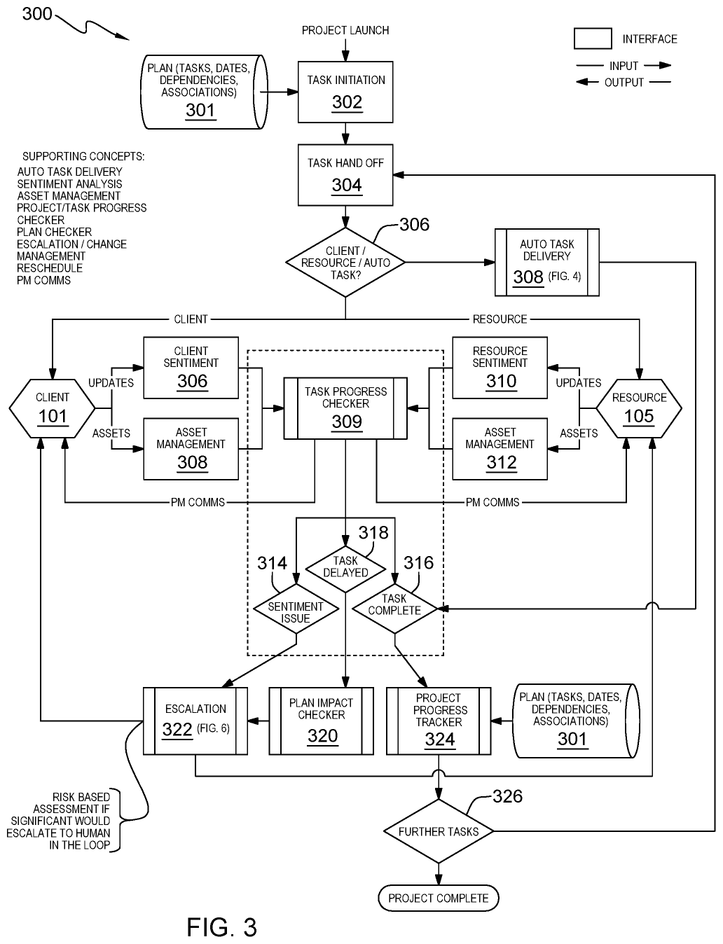

FIG. 3 depicts a flowchart of the operational steps of the project launch process 300, in accordance with an embodiment of the present invention. The method(s) and associated process(es) are now discussed, over the course of the following paragraphs, with extensive reference to FIG. 3, in accordance with one embodiment of the present invention.

The project launch validates that all pre-requirements for a successful delivery are met. For example, the module 110 is assigned to recognized client 101, scoped, costed and to agreed margin/profitability, resource(s) 105 are awarded and contracts are signed, client 101 signed and approved of the project, milestones are created, and project is planned, and the project is launched at the appropriate time. In some embodiments, the entire service functionality or specific steps can be bypassed for projects requiring a lower level of checks and balances such as internal only projects (no client 101), own resources (no contracts) etc.

In the depicted embodiment, the module 110 initiates 302 the task to be completed (this may be the first task or any task after a completed or overridden task). The module 110 accesses the plan 301 to determine the client 101, resource(s) 105, task requirements, and the like. The module 110 distributes 304 the task to the proper resource(s) 105. The module 110 determines 306 if the task is completed by the client 101, a resource(s) 105, or is an automatic task.

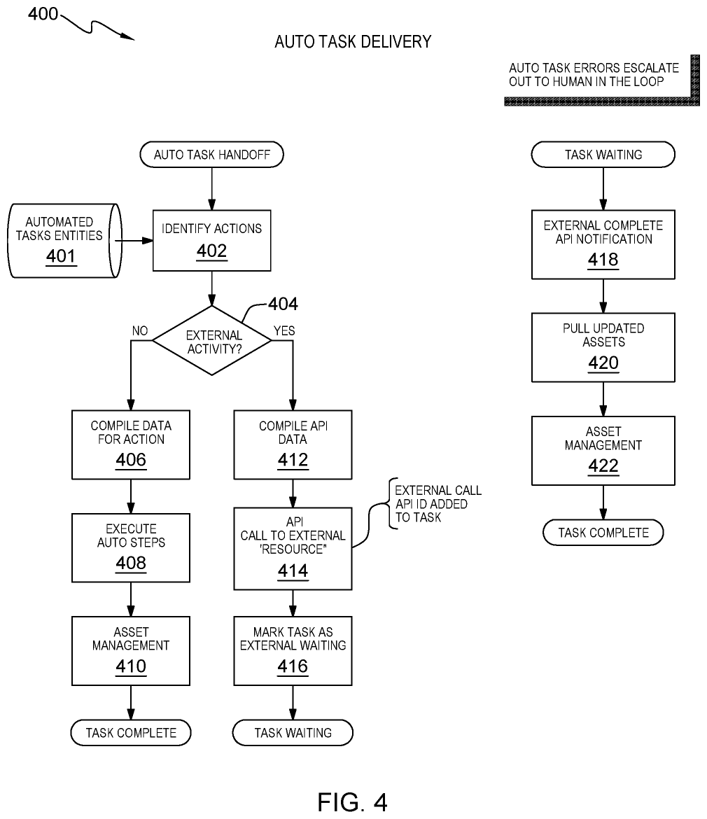

In instances where the task is an automatic task (See FIG. 4), the auto task delivery protocol 308 is initiated. This is where the task is automatically completed by module 110 or a third-party program that is able to automatically complete all the requirements of the task. For example, drafting a contract from a template where the names of the parties and pricing is needed to be input. The module 110 determines that the task was completed 316, updates the project progress tacker 324, and determines if another task is required to be completed 326 for the project to be completed.

In the instances where the task submitted to the client 101 or the resource(s) 105, the module 110, in the depicted embodiment, follows a similar procedure. The module 110 receives 306 updates from the client 101, and/or receives updates from the resource 310. The module 110 receives the incoming messages from one or both parties either directly and via 3^{rd} party communication methods (e.g. Instant messaging, email etc.). These incoming messages are interpreted by, but not limited to, an automated sentiment analysis module or system to measure the party's engagement, satisfaction and assess for specific issue types. These measures allow specific courses of action to be initiated by the module 110. The courses of action may be without human involvement or may require a third party to mediate or mitigate any issues. Examples of this are disparaging comments about client 101 or other team members, requests for help, concerns about delivery timeline.

Additionally, the module 110 receives assets from the parties. The module 110 ensures that all assets related to the delivery of the project are appropriately classified, stored and shared. The module 110 utilizes, in one embodiment, a secure cloud storage environment with associations to the project and usage rights allowing assets to be suitable displayed as ‘part of the project’. In some embodiments, each asset is classified according to the type of file, owner, relation to other versions of the asset, purpose and relevance to the project (e.g. Input/WIP/Draft/Complete/Approved). In additional embodiments, received assets are moved from Instant Messages, Incoming APIs, Emails and direct upload to the correct workroom with version management, showing owner/updater etc. Additionally, outgoing assets, in some embodiments, are moved from the “workroom” to outgoing communication based on the correct version date and owner.

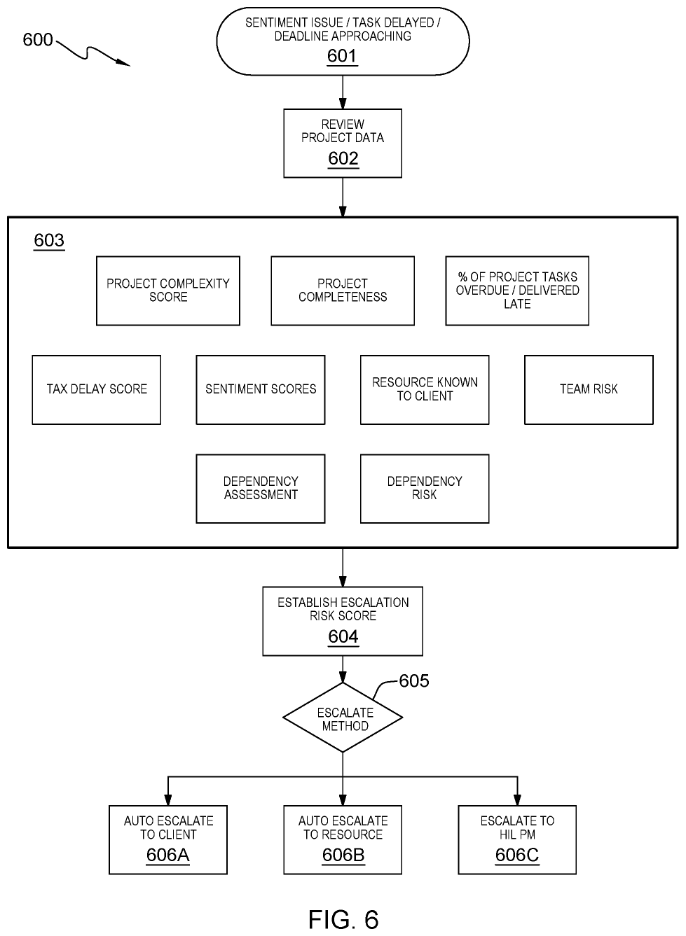

The module 110 is continuously, and in some embodiments automatically, processing the updates and assets from the parties through a task progress monitoring system 309. The task progress monitoring system 309 evaluates the progress and risk for a given task and, in some embodiments the overall project. The task progress monitoring system 309 is constantly assessed while a task is active and can trigger targeted communications to the client 101 or resource(s) 105, the more detailed escalation and change asset management service 312 if concerns are identified, when a task is completed this service triggers a project process check 320 and hand off to the next task/project close out functionality. For example, the task progress monitoring system 309 may provide schedule assessment, resource engagement, client 101 sentiment, resource(s) 105 sentiment, task completion, dependency risk, and the like. Based on the assessment of the task progress monitoring system 309, the module 110 can determine an appropriate reaction to the client 101 and the resource(s) 105 actions. The module 110 is able to process a sentiment issues 314 determined by the task progress monitoring system 309 process an escalation assessment 322 (FIG. 6), wherein an escalation risk score is calculated, and a determination is made if a third-party intervention is required. The module 110 is able to determine where a task is delayed 318, how the delay affects the overall project, and if this delay results in an adjustment to the escalation 322 of the project.

FIG. 4 depicts a flowchart of the operational steps in the project management task delivery process 400, in accordance with an embodiment of the present invention. The method(s) and associated process(es) are now discussed, over the course of the following paragraphs, with extensive reference to FIG. 4, in accordance with one embodiment of the present invention. FIG. 4 depicts an embodiment of step 302 of FIG. 3, wherein the task once initiated is “handed off” to the proper party to complete.

Module 110 identifies the action 402 of the task to be completed based on the project plan. In some embodiments, the module 110 accesses an automated task entities database 401 to collect data associated with a previously completed or record task. This may include manual or automatic requirements, whom to assign the task to, time line for the task, etc. The module 404 determines if the task requires external activity 404 or not. Within a given project some tasks are not allocated to a human delivery resource but are either actions for the module 110 (or sub system) or are assigned to an external automation service, executable program, application program, dynamic-linked libraries or database, or the like. The automated task delivery process is pre-programmed to deliver these tasks, which require external activity to the proper party or system, wherein the logic and actions stored in a series of entities and microflows. The module 110 establishes an application program interface 412, which communicates 414 with the external resource to complete the task. Once the communication has been initiated, the module 110 marks the task as active and in progress. In some embodiments, the module 110 identifies that the task is being processed by the external resource 416 the appropriate action is initiated and if the task has a wait period. The related listener API and logic will react when the external activity is completed 418, provides the completed (or updated) assets 420 so that most current asset is associated with the project. The module 110 then manages 422 the assets in relation to the parties and the project.

An example of this interaction using an external automation service could be a client 101 video requiring subtitles, rather than assign this to a resource it can be passed as a request to the Trint® transcribe and subtitle platform. The Automated Task Delivery service is pre-programmed with the required actions, logic including which API configuration to utilize enabling the specific required video asset to be made available to the external service and once completed a modified video and script file are downloaded to the project data.

In an example where the activity/task can be completed internally, the module compiles 406, the data for the action. Executes 408 the steps, procedures, or processes which are necessary to complete the task. The module 110 then manages 410 the asset in relation to the parties and the project.

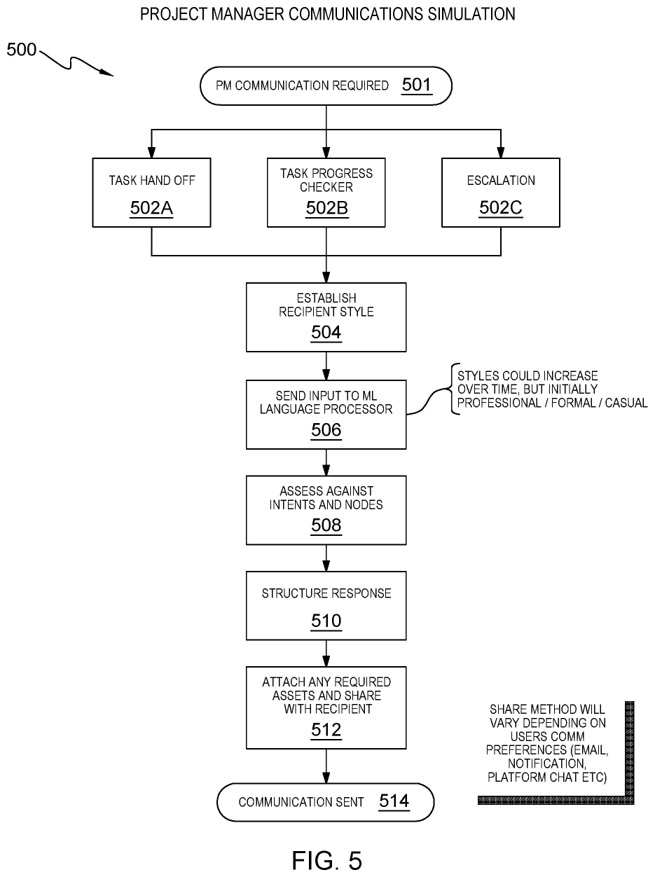

FIG. 5 depicts a flowchart of the operational steps in the project management communication protocol process 500, in accordance with an embodiment of the present invention. The method(s) and associated process(es) are now discussed, over the course of the following paragraphs, with extensive reference to FIG. 5, in accordance with one embodiment of the present invention.

In situations where a communication is required between parties, the module 110 is able to initial the communication protocol 111. The communication protocol 111 is designed to mimic a project manager to assist in responding to a question, comment, situation, or issue as if it was generated by an actual human project manager. The communication protocol 111 identifies a situation 502A, 502B, 502C, or the like which require attention. The communication protocol 111 analyzes 504 historic data associated with the recipient's style, language, tone, formality (professional/casual) of their communication style. The communication protocol 111 submits 506, the data to a machine learning (ML) or artificial intelligence (AI) system, wherein the system processes the language and communications which required the communication protocol 111 involvement. This may be over a set period of time or may be since the start of the parties. The results of the ML or AI are assessed 508 in relation to the intent of the party's inputs. The intent of the inputs are the purpose or goals expressed. In some embodiments, the inputs are separated out into various nodes. The nodes identify different aspects of the party's inputs. Communication protocol 111 or the third-party assessment system is able to assess each type of node independently or as a sum of the nodes. For example, dialog nodes, confirmation nodes, intent nodes, entity nodes, transfer nodes, service nodes, or the like.

In one embodiment, the nodes are analyzed in an ontology, wherein a hierarchical structure containing a plurality of nodes, wherein each node represents an actional intent. The nodes are sorted and assessed by a confidence score which is calculated by the communication protocol 111 or a third-party system.

The communication protocol 111 then formulates 510 a response to the party based on the assessment of the data collected in the prior steps. The response is designed to choose the correct dialog flow for responding to the party to best solve the problem, issue, comment, concern, or question. The communication protocol 111 identifies 512 any tasks, documents, files, or data to the response which can further assist the party in reaching a resolution. The communication is then sent to the party 514 through the various communication means which is deemed most appropriate based on the party's past input methods or preferences.

FIG. 6 depicts a flowchart of the operational steps in the project management escalation assessment process 600, in accordance with an embodiment of the present invention. The method(s) and associated process(es) are now discussed, over the course of the following paragraphs, with extensive reference to FIG. 6, in accordance with one embodiment of the present invention.

When a sentiment issue has been identified 601, the module 110, a task is delayed or a deadline is approaching without an update, this service produces an escalation risk score. The module 110 reviews 602 the project data. The project data may include, but not limited to, Specific project complexity, project completeness, percentage of project task overdue or delivered late, current task delay, latest and average client and personnel sentiment, resources known to client risk, team risk, dependency assessment, dependency risk, and the like. Based on these and other relevant factors, the module 110 calculates 604 an escalation risk score. Based on the escalation risk score, the module 110 assess 605 the escalation method. The module 110 is able to escalate to the client 606A, the personnel 606B, or a “Human-in-Loop” Project Manager 606C. The escalations to the client 101 and the resource(s) 105 use carefully constructed and dynamically selected change management language to minimize the impact and optimize the end user experience/engagement. Escalations to the HIL PM is in effect a failsafe to ensure client 101 satisfaction, when a project is at significant risk, a client service specialist (HIL PM) can be informed, simply see the cause of escalation and directly intervene in the project to ensure a sustained successful outcome.

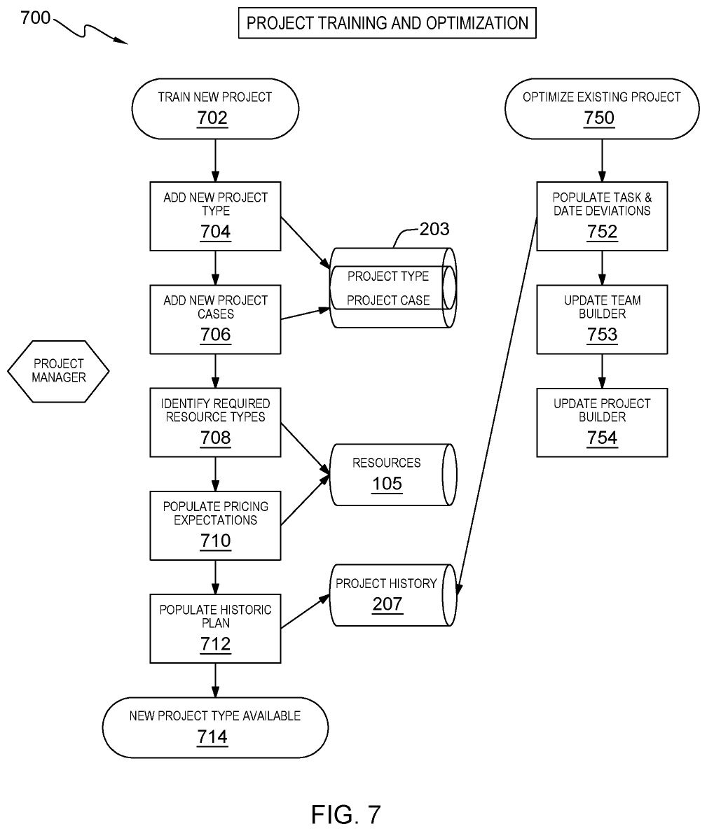

FIG. 7 depicts a flowchart of the operational steps in the project management training and optimization process 700, in accordance with an embodiment of the present invention. The method(s) and associated process(es) are now discussed, over the course of the following paragraphs, with extensive reference to FIG. 7, in accordance with one embodiment of the present invention.

The module 110 is able to create new project templates or update existing project templates. The module 110 activates the project training 702 for previously unknown project types. The module 110 incorporates inputs into a project detailing functionality protocol. This includes, but not limited to the project type 704, the project cases 706, including specific questions for a Hiring Manager, different configurations for the project type, required input files, Project Tasks and dependencies, required resources 708, and price expectations 710. The project types and cases are stored in database 203, the resource(s) 105 information is stored in a database. In some embodiments, a historic plan is populated 712 with the newly trained project and tested to create a hypothetical project history, which is then stored in database 207. The new project is then made available 714 to the module 110 for future projects.

In some embodiments, external resources are incentivized to train new project types, though a training incentive setup, where they earn a percentage of future revenue achieved through the use of the project type they have trained. They are recommended to be available as Human in the Loop support for the early uses of the new project type.

In the process once a project is complete, is able to review the data (communications, assets, teams, tasks, etc.) of the project to train the module 110 and sub-systems as well as optimize 750 the module 110 and the sub-systems to create an improved project design for future projects. The module 110 ensures that future delivery performance is optimized based on Learning from Historic Project delivery. By comparing the project template used for the requested project, through populating 752 the task deviation data, and the time deviation data. Delays to specific tasks or longer deliveries are automatically considered in future project plans by the intelligent plan builder service. The module 110 is able to see the accuracy of the project template and detect deviations and analyze the possible reasons for the deviations. The module 110 analyzes 753 the team delivery and in particular interactions between team members. Poorly performing resource pairings who did not make an effective team are marked to prevent future usage in a project team. Individual resources 105 and clients 101 who create a negative experience are flagged for review to ensure that bad experiences are not repeated on future projects. The module 110 updates the project templates 754 for future projects. In some embodiments, previously created templates are maintained for future use.

In additional embodiments, any specific projects that need re-training based on significant delays or project task changes are highlighted to the original trainer and support team.

In some embodiments, the module 110 uses an integral understanding of client, resource(s) and project performance to forecast future performance. All resources, clients and projects are assessed and scored on completion of a project. These scores are then assessed to establish the likely outcome of a specific team of resources/client/project type. Indicators such as new to client, no shared experience, new project type are outputted in addition to an overall success forecast (in effect a risk measure.)

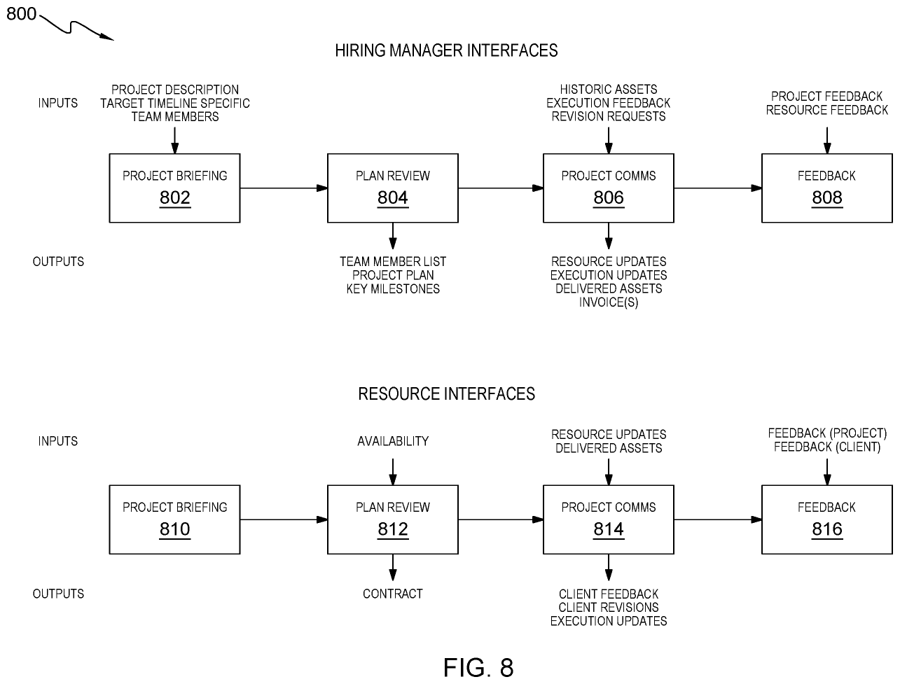

FIG. 8A depicts flowcharts of embodiments of the hiring manager interfaces 800A and the resources interfaces 800B, in accordance with embodiments of the present invention. For the hiring manager interfaces 800A, the hiring manager is able to interact with the project briefing interface 802 to project their requests for the project. The hiring manager is able to view the various team members, project milestones, and other aspects of the project through the plan review interface 804. The hiring manager is able to interact with the various team members and communicate with the system through the project comms interface 806. In some embodiments, the hiring manager is able to provide feedback about the team members and the project through a feedback interface 808. The Resources interface 800B are provided with the project briefing 810 to see the various requirements of the project. The resources are able to view the plan review interface 812 and provide their availability, acceptance of joining the team, and signing various contracts. The resources are able to interact with the project comms interface 814 to project updates on the project, deliver assets to the project, communicate with the hiring manager, and the like. In the feedback interface 816, the resources are able to provide their feedback on the project, the other resources, the hiring manager, and the like. In some embodiments, the resources are able to see their feedback received by other team members.

FIG. 9, computer system/server 1112 in cloud computing node 1110 is shown in the form of a general-purpose computing device. The components of computer system/server 1112 may include, but are not limited to, one or more processors or processing units 1116, a system memory 1128, and a bus 1118 that couples various system components including system memory 1128 to processor 1116.

Bus 1118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1112 typically includes a variety of computer system readable media. Such media may be any available media that is accessible by computer system/server 1112, and it includes both volatile and non-volatile media, removable and non-removable media.

System memory 1128 can include computer system readable media in the form of volatile memory, such as random-access memory (RAM) 1130 and/or cache memory 1132. Computer system/server 1112 may further include other removable/non-removable, volatile/non-volatile computer system storage media. By way of example only, storage system 1134 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1118 at least one data media interface. As will be further depicted and described below, memory 1128 may include at least one program product having a set (e.g., at least one) of program modules that are configured to carry out the functions of embodiments of the invention.

Program/utility 1140, having a set (at least one) of program modules 1142, may be stored in memory 1128 by way of example, and not limitation, as well as an operating system, one or more application programs, other program modules, and program data. Each of the operating system, one or more application programs, other program modules, and program data or some combination thereof, may include an implementation of a networking environment. Program modules 1142 generally carry out the functions and/or methodologies of embodiments of the invention as described herein.

Computer system/server 1112 may also communicate with one or more external devices 1114 such as a keyboard, a pointing device, a display 1124, etc.; one or more devices that enable a user to interact with computer system/server 1112; and/or any devices (e.g., network card, modem, etc.) that enable computer system/server 1112 to communicate with one or more other computing devices. Such communication can occur via Input/output (I/O) interfaces 1122. Still yet, computer system/server 1112 can communicate with one or more networks such as a local area network (LAN), a general wide area network (WAN), and/or a public network (e.g., the Internet) via network adapter 1120. As depicted, network adapter 1120 communicates with the other components of computer system/server 1112 via bus 1118. It should be understood that although not shown, other hardware and/or software components could be used in conjunction with computer system/server 1112. Examples, include, but are not limited to microcode, device drivers, redundant processing units, external disk drive arrays, RAID systems, tape drives, and data archival storage systems, etc.

In certain embodiments, the server computer 100 has the architecture of computing node 1110. In certain embodiments, the server computer 100 is part of a cloud environment. In certain alternative embodiments, the server computer 100 is not part of a cloud environment.

### Cloud Embodiments

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

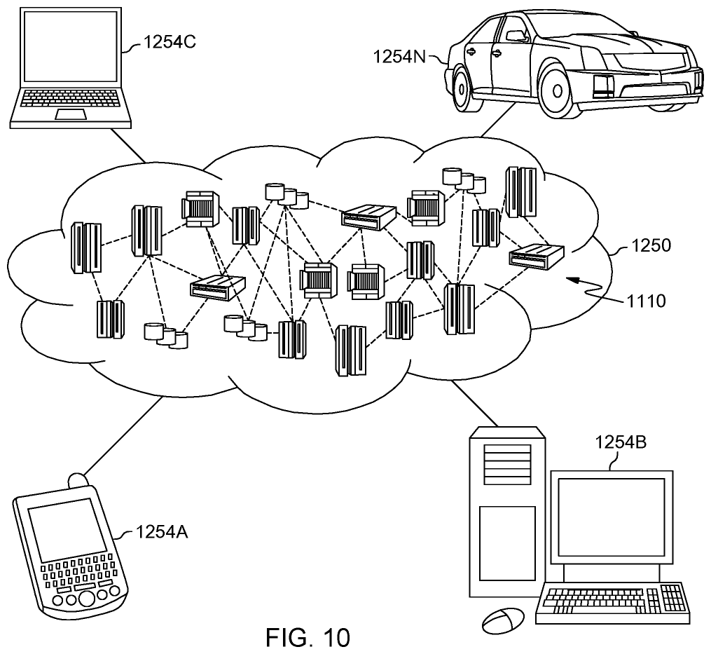

Referring now to FIG. 10, illustrative cloud computing environment 1250 is depicted. As shown, cloud computing environment 1250 comprises one or more cloud computing nodes 1110 with which local computing devices used by cloud consumers, such as, for example, personal digital assistant (PDA) or cellular telephone 1254A, desktop computer 1254B, laptop computer 1254C, and/or automobile computer system 1254N may communicate. Nodes 1110 may communicate with one another. They may be grouped (not shown) physically or virtually, in one or more networks, such as Private, Community, Public, or Hybrid clouds as described hereinabove, or a combination thereof. This allows cloud computing environment 1250 to offer infrastructure, platforms and/or software as services for which a cloud consumer does not need to maintain resources on a local computing device. It is understood that the types of computing devices 1254A-N shown in FIG. 12 are intended to be illustrative only and that computing nodes 1110 and cloud computing environment 1250 can communicate with any type of computerized device over any type of network and/or network addressable connection (e.g., using a web browser).

Thus, in certain embodiments, software or a program, implementing prior compare processing in accordance with embodiments described herein, is provided as a service in a cloud environment.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

1. A method comprising:
receiving, by at least one processor, a request for a project;
analyze, by at least one processor, the request to extract a project type and at least one project requirement;
converting, by one or more processors, the at least one project requirement into a set of tasks, wherein the set of tasks are generated based on the analysis of the project type and the at least one project requirements;
selecting, by at least one processor, at least one resources, wherein the resources are based on the set of tasks, wherein the selection comprises,
identifying, by at least one processor, a compatible resource based on the specific task, wherein at least one compatible resource is identified for each of the set of tasks and each compatible resource has an associated value,
selecting, by at least one processor, one of the compatible resources for each of the set of tasks, and
comparing, by at least one processor, the selected resources, wherein the selected resources are analyzed to determine if the selected resources are compatible, wherein a set of compatible resources is identified and selected;
manipulating, by at least one processors, the set of tasks based on the selected resources;
generating, by at least one processor, a quote based on the selected resources;
receiving, by at least one processor, a product from one selected resource
manipulating, by at least one processor, the received product based on a set of requirements associated with the next selected resource, wherein upon the completion of a final task an asset is formed;
providing, by at least one processor, the asset to the party which sent the project request, wherein a confirmation is received based on the approval of the asset; and
storing, by at least one processor, the requested project associated data.

2. (canceled)

3. The method for monitoring and assessing a project of claim 1, further comprising,
monitoring, by at least one processor, communication between the selected resource and a client,
performing, by at least one processor, a natural language processing on the monitored communication, wherein a set of communication data is created, and
calculating, by at least one processor, a sentiment score based on an analysis of the set of communication data.

4. The method for monitoring and assessing a project of claim 1, further comprising, calculating, by at least one processor, a project impact value based on the time between the receipt of the products.

5. The method for monitoring and assessing a project of claim 3, further comprising generating a response, wherein the response generation, comprises,
processing, by at least one processor, the monitored communications and identifying a client communication style,
generating, by at least one processor, a response based on the client communication style, and
submitting, by one or more processors, the generated response to the client.

6. (canceled)

7. (canceled)

8. A computer program product for monitoring and assessing a project, the method comprising:
one or more computer readable storage media and program instructions stored on the one or more computer readable storage media, the program instructions comprising:
program instructions to receive a request for a project, wherein the request has a set or requirements;
program instructions to extract a project type from the request by processing the requirements;
program instructions to convert the set of requirements to a set of tasks;
program instructions to select at least one resources, wherein the selection process comprises:
program instructions to identify at least one resource who is compatible with at least one of the set of tasks, by comparing a set of data associated with the at least on resource and the at set of tasks to determine if a threshold value has been reached, wherein at least one resource is identified with each of the tasks,
program instructions to compare the identified resources, wherein the identified resources data is compared to determine the compatibility of the resources, and
program instructions to create a team, wherein the team is comprised of at least one compatible resource capable of completing the set of tasks and the resources are each assigned at least one of the set of tasks;
program instructions to receive a product from a resource upon the submission by the resource;
program instructions to process the product to determine the completion of the assigned task, wherein if it is determined that the assigned task is completed the product is sent to the next resource based on a chronological order of the set of tasks, wherein the product is manipulated at each task and after the final task an asset is formed; and
program instructions to present the asset to a client after the last task has been completed.

9. (canceled)

10. (canceled)

11. (canceled)

12. (canceled)

13. (canceled)

14. A computer system for monitoring and assessing a project, the computer system comprising:
one or more computer processors, one or more computer readable storage media, and program instructions stored on the one or more computer readable storage media for execution by, at least one of the one or more processors, the program instructions comprising:
program instructions to receive a request for a project, wherein the request has a set or requirements;
program instructions to convert the request into a project type and set of tasks based on the received project and set of requirements;
program instructions to manipulate the set of tasks based on a chronological processing of the set of tasks relative to the request;
program instructions to select at least one resources, wherein the selection process comprises:
program instructions to identify at least one resource who is compatible with at least one of the set of tasks, wherein at least one resource is identified with each of the tasks,
program instructions to process the identified resources, wherein the identified resources are compared to determine the compatibility of the resources, and
program instructions to generate a team, wherein the team is comprised of at least one compatible resource capable of completing at least one of the set of tasks;
program instructions to receive a product from a resource upon the submission by the resource;
program instructions to analyze the product to determine the completion of the assigned task, wherein if it is determined that the assigned task is completed, program instructions to manipulate the product to prepare the product be transferred to the next resource based on a chronological order of the set of tasks;
program instructions to present the asset to a client after the last task has been completed; and
program instructions to store the asset, wherein the team of resources, set of tasks are processed and converted into a template.

15. (canceled)

16. (canceled)

17. (canceled)

18. (canceled)

19. (canceled)

20. The computer system for monitoring and assessing a project of claim 14, further comprising generating a template, wherein the generating of the template comprises,
program instruction to analyze a completed project,
program instruction to compare, the completed project to a plurality of previously completed projects,
program instruction to analyze the differences between the completed project and the previously completed projects, and
program instruction to determine if the completed project differs from the previously completed projects, and if it is determined that the completed project differs from the previously completed projects, program instruction to generate a new project template which includes the completed project and the differences between the completed project and the previously completed projects.

21. The computer program product for monitoring and assessing a project of claim 8, further comprising:
program instructions to identify a previously completed task which is substantially similar to one of the set of tasks, wherein the previously completed task was automated;
program instructions to compile data associated with the previously completed task; and
program instructions to execute the task based on the compiled data and at least one identified action.

22. The computer program product for monitoring and assessing a project of claim 8, further comprising, populating a task time frame deviation based on the completed task information, wherein the task time frame deviation is used for future escalation value calculations.

23. (canceled)

24. (canceled)

25. The computer program product of claim 8, further comprising, building, a collection of the resources, wherein the resources are compared to one another to determine compatible resources.

26. The computer program product of claim 8, further comprising, generating a plurality of project types, wherein each project type has varying sets of tasks, based on at least one previously completed project.
